(19) United States
(12) Patent Application Publication
(10) Pub. No.: US 2007/0202280 A1
(43) Pub. Date: Aug. 30, 2007

(54) FAST DRYING INK JET RECORDING MEDIUM HAVING AN ANIONIC SURFACE LAYER AND A CATIONIC UNDERLAYER

(75) Inventors: Khizyr K. Khoultchaev, Branford, CT (US); Cau T. Ho, East Haven, CT (US); Zhong Xu, Holden, MA (US); Stephen Xipeng Liu, East Providence, RI (US)

Correspondence Address: BARLOW, JOSEPHS & HOLMES, LTD., 101 DYER STREET, 5TH FLOOR, PROVIDENCE, RI, 02903, US

(73) Assignee: ARKWRIGHT, INC., Fiskeville, RI (US)

(21) Appl. No.: 11/678,239

(22) Filed: Feb. 23, 2007

Related U.S. Application Data
(60) Provisional application No. 60/743,350, filed on Feb. 24, 2006.

(51) Int. Cl. B41M 5/50

(52) U.S. Cl. 428/32.24

(57) ABSTRACT

A fast drying inkjet medium comprising at least one cationic archival layer and at least one anionic or non-ionic fast-dry overcoat layer.

### CROSS-REFERENCE TO RELATED APPLICATION

This application claims the benefit under 34 U.S.C. § 119(e) to U.S. Provisional Patent Application Ser. No. 60/743,350, filed Feb. 24, 2006, the contents which are incorporated herein by reference.

### BACKGROUND

Modern ink-jet printing systems produce colored images on papers, films, and other imaging media that can be used in many different applications. The printed media can be used as indoor and outdoor signage, posters, bulletins, advertising banners, and the like to provide colorful graphic displays. The ink-jet printing systems employ various digital technologies, inks, and ink-jet printers to produce high quality printed images on the imaging media.

While an ink jet recording medium must meet initial performance criteria such as low ink migration, large color gamut, good color fidelity and high image resolution, an important goal in making media for a number of ink-jet and related printing methods is to make a recording medium that holds the initial good quality image overtime when the imaged “media” is exposed to various environmental conditions, such as light, air/ozone, humidity, etc. This is particularly important for papers, photographs and other media intended for archival purposes.

U.S. Pat. No. 5,672,424 discloses an ink jet transparencies for dye-based inks comprising a supporting substrate with a first coating layer comprised of an anionic layer and a second cationic layer situated on the top of the first anionic layer with a lightfastness-inducing agent. The patent, incorporated herein by reference thereto, discloses numerous anionic and cationic species used as components in layers for dye-based inks.

It is known in the prior art to use cationic polymers and additives in ink receptive layers. For example, U.S. Pat. Nos. 6,447,882 and 6,632,486 disclose an ink recording element having an image receiving layer containing an anionic pigment, an organic-anionic binder and an organic cationic mordant in a single layer. U.S. Pat. No. 6,447,882 is similar and discloses a porous overcoat layer comprising an inorganic pigment and an organic, anionic binder. The ink jet recording elements are discloses as being primarily an anionic image-receiving layer with the majority of the image-receiving layer being an anionic inorganic pigment or an anionic binder.

U.S. Pat. No. 6,936,315 discloses an ink jet recording medium designed to prevent bronzing. The ink jet medium achieves this by controlling the degree of cat ionization in the ink-receiving layer at the outermost surface to be less than the remainder of the layer. When a second ink-receiving layer is employed it is described as a similar cationic ink-receiving layer.

Japanese Patent Application No. JP2002/240414 discloses an ink-receiving layer consisting of ultra-fine particles, a binder and a cationic dye fixative. An anionic polyurethane polymer may be applied to the sheet after image recording is complete to fix the image within the sheet. The anionic urethane polymer is not a layer that is present when the mage is applied to the ink receiving layer, but is subsequently added as a protective layer.

Most inks used in ink-jet printing devices are aqueous-based inks containing water as their primary component. The aqueous-based inks contain molecular dyes or pigmented colorants. Small amounts of water-miscible solvents, such as glycols and glycol ethers, may be present. The intended medium (e.g., paper or film) may be coated with an ink-receptive composition. During printing/imaging, dyes or colorants from the ink penetrate into the ink-receptive coating on the medium. Water and other solvents, if present, evaporate from the printed medium as the medium is dried. By “ink-receptive coating” or “ink-receptive composition”, it is meant coatings or compositions that are capable of receiving some components of aqueous-based inks. The coatings or compositions may also receive non-aqueous based inks in some instances.

It is known that most dye-based inks are susceptible to light and air/ozone fade, resulting in poor longevity of the imaged “media”. The fate of dyes in an ink-receptive coating depends strongly on the physical structure (e.g. porosity) as well as the chemical structure of the coating. In general, ink-receptive coatings can be classified into three categories based on their physical structure: swellable (gel) type, porous/microporous type and hybrid type. A swellable type coating is comprised primarily of water-swellable polymer resins. Upon drying, most dyes are embedded into the polymer resin that protects them to some extent from interaction with air/ozone. Therefore, a swellable type coating usually protects dyes from air/ozone fade reasonably well. The key disadvantage of a swellable type coating is its slow dry time. A porous/microporous type coating, on the other hand, is comprised primarily of water-insoluble organic/inorganic particles (e.g. alumina, silicate, etc.) and has significant porosity. Porous/microporous coatings tend to provide very fast drytimes due to capillary effects. Dyes reside on the inner surfaces of a porous coating and fade overtime through interaction with air/ozone. The hybrid type coating is comprised of significant amounts of both water-swellable polymers and water-insoluble organic/inorganic particles. It has longer dry time compared with a porous coating, but provides better air/ozone fastness for dye inks in return.

For an archival inkjet recording medium, a group of performance criteria, including fast dry time, low ink migration, large color gamut, good color fidelity, high image resolution, little tackiness, light fastness, air/ozone fastness, humidity fastness must be met at the same time. Customers may also demand a glossy, satin or matte finish as well as printability with many types of inks (sometimes called universal printability). Universal printability means that the recording medium can be imaged by either dye or pigment inks without significant image defects, such as cracking in the images. It is a tremendous challenge to meet all criteria by a single ink-receptive coating. Several layers of different functionalities are required.

### SUMMARY OF THE INVENTION

The invention relates to a novel archival medium and methods for making it. The invention involves several aspects. One of the essential aspects is the use of at least two ink-receptive layers of opposite charge nature. Another of the essential aspects is the use of specific types and combinations of polymeric resins and inorganic/organic particles in the ink-receptive composition. The instant invention comprises a design that has an anionic fast dry surface layer laid on a cationic archival under layer. The surface layer is constructed to be less swellable than the cationic archival layer in order to perform well with pigmented inks. The surface layer also functions as a protective layer for the archival layer. The surface layer overlying the cationic archival layer is preferable an anionic layer.

Other objects, features and advantages of the invention shall become apparent as the description thereof proceeds when considered in connection with the accompanying illustrative drawings.

### BRIEF DESCRIPTION OF THE DRAWING FIGURES

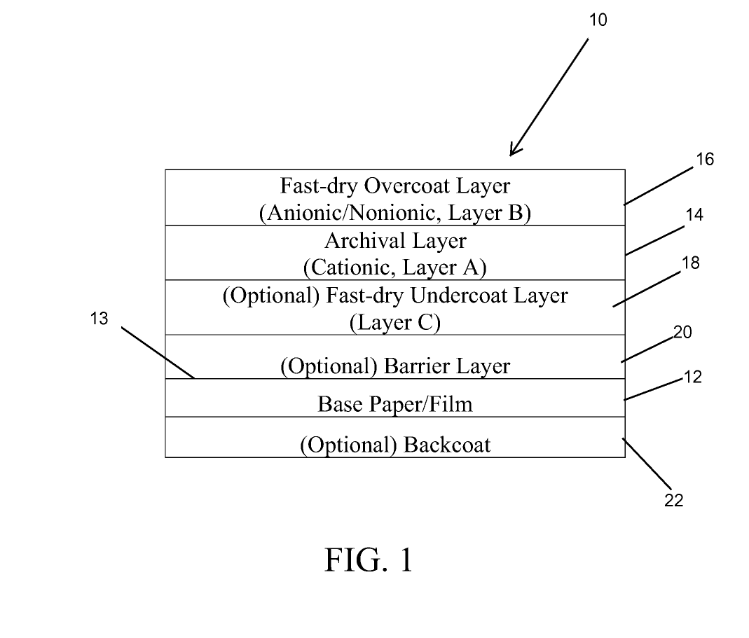

In the drawings that illustrate the best mode presently contemplated for carrying out the present invention, FIG. 1 is a schematic illustration of the coating layers on the media.

### DETAILED DESCRIPTION OF THE PREFERRED EMBODIMENT

The instant ink jet recording medium comprises a multilayer medium having a substrate, a cationic archival layer overlying the substrate and an anionic layer overlying the cationic archival layer. The opposite charge characterization of the two layers refers to both the components in the layer and the overall opposite charge nature of each layer.

Referring to FIG. 1, the ink-jet recording media of the present invention is shown generally as 10. As will be described in greater detail below, the ink jet recording media of the present invention 10 comprises a substrate 12, a cationic archival layer 14 overlying a front or imaging surface 13 of substrate 12, and a surface layer 16 overlying cationic archival layer 14, preferably an anionic surface layer. In addition to the above layers, an optional fastdry undercoat layer 18 and an optional barrier layer 20 may be employed between the imaging surface 13 of substrate 12 and cationic archival layer 14. An optional back coat layer 22 may be employed on the side of substrate 12 that does not have imaging surface 13.

The optional, curl-control back coat 22 can be applied to the back surface of substrate 12 to help reduce curling and cockling of the media 10. Optionally, coating 22 can be replaced with coating layers 14 and 16, and optional layers 18 and 20, to produce a symmetrical medium that can be used without regard to “sidedness”.

Referring to FIG. 1, one embodiment of the ink-jet recording media is shown graphically at 10. The ink-jet recording media 10 of the present invention are constructed using a suitable substrate material 12. For example, the substrate material 12 may be a paper material. Paper substrates 12 are known in the ink-jet industry and any suitable paper may be used in the present invention. For example, plain papers, clay-coated papers, or resin-coated papers may be used. The base weight of the paper is typically in the range of about 70 to about 260 grams per square meter (gsm). The thickness of the paper is typically in the range of about 3 mils to about 10 mils. The paper substrate 12 may be pre-treated with conventional adhesion promoters to enhance adhesion of the coatings to the paper. In other embodiments, the paper substrate 12 may be coated with a primer or optional moisture barrier layer. For example, a radiation-curable barrier coating may be applied to the substrate 12 and subsequently cured with UV light or electron beam irradiation. In addition, optional fast-dry undercoat layer may be a fast drying UV-cured layer. It is also recognized that the paper substrate 12 can have different surface finishes. For example, glossy paper substrates can be used. In other embodiments, satin-like or semi-glossy substrates can be used. In still other embodiments, matte-like substrates can be used.

The substrate 12 material has two surfaces. The first surface, which is coated with the ink-receptive layers in accordance with this invention, may be referred to as the “front” or “imaging” surface. The second surface, which is opposite to the first surface, may be referred to as the “back” or “non-imaging” surface.

Well known coating techniques such as Meyer rod, roller, blade, wire bar, dip, die-extrusion, air knife, curtain, slide, doctor knife and gravure also can be used to apply the cationic archival layer 14 and the fast-dry overcoat layer 16 in accordance with this invention. The cationic archival layer 14 is preferably applied with a coating weight between about 2 g/m² (gsm) and about 20 g/m², more preferably with a coating weight between about 2 g/m² and about 10 g/m². The anionic fast-dry overcoat layer 16 is preferably applied with a coating weight between about 1 g/m² and about 10 g/m², more preferably with a coating weight between about 1 g/m² and about 5 g/m². The optional fast drying undercoat layer is preferably applied with a coating weight between about 2 g/m² and about 30 g/m², more preferably with a coating weight between about 2 g/m² and about 10 g/m².

The fast-dry undercoat layer 18 can be applied to produce a medium with good drying. A preferred way to produce this fast dry layer is to use a layer similar to the anionic fast-dry overcoat layer or to apply a radiation curable coating, preferably acrylate-based, then radiation cure the radiation curable coating wholly or partially. The preferred form of radiation for this is ultra-violet (UV) light curing. However, other radiation curing technologies, such as x-ray or electron-beam curing, as well as other methods of forming permeable coatings with the appropriate permeability also can be used within the scope of the invention. During manufacture of the media, a radiation-curable composition is applied to the substrate and, thereafter, radiation from an electron beam, x-ray source or ultraviolet (UV) light source is used to cure this radiation-curable coating. In ultraviolet (UV) light radiation, photoinitiators (photosensitizers) typically are used to initiate the polymerization. The radiation-cured coating is typically produced from a curable coating that comprises acrylate-based oligomers or monomers or a combination of them, and it can comprise urethane-modified acrylic monomers, or hydroxyl-terminated urethane oligomers. The coating may also contain additives such as inhibitors, surfactants, waxes, cure accelerators, defoaming agents, pigments, dispersing agents, optical brighteners, UV light stabilizers (blockers), UV absorbers, adhesion promoters, and the like.

In the manufacturing process for a UV-cured fast-dry undercoat layer, one or more UV-curable oligomers and or monomers are blended together with a photoinitiator and any additives. The mixture may be heated to reduce its viscosity. The coating formulation may be applied to the substrate 12 by any suitable method. Suitable methods for application of the monomers and/or oligomers (leading to coating 18) to the paper substrate 12 include, for example, Meyer-rod, roller, blade, wire bar, dip, solution extrusion, air-knife, curtain, slide, doctor-knife, and gravure methods. The vehicle-permeable radiation-cured coating 18 preferably has a coating weight between about 2 g/m² and about 30 g/m², and most preferably a coating weight of about 2 g/m² to about 20 g/m².

Typically, the UV light has a wavelength in the range of about 150 nm to about 400 nm. Commercial UV light curing equipment may be used. Such equipment typically includes an UV light source (e.g., a tubular glass lamp), reflectors to focus or diffuse the UV light, and a cooling system to remove heat from the lamp area. After the curing steps, the UV-cured coating may be treated with corona discharge to improve its adhesion to cationic archival layer 14.

The cationic archival layer and anionic fast drying overcoat layer may have additional components that do not interfere with the overall ionic nature of the layers and their relationship to each other and their compatibility with pigment-based inks. For example, the layers may contain other film forming polymers and pigments.

In addition, the back surface 15 of the substrate 12 may be coated with a polymeric coating 20 that further helps prevent moisture from penetrating into the back surface 15 of the substrate 12. The polymeric coating 20 on the back surface of the substrate enhances the substrate's dimensional stability and helps minimize curling, cockling, and other defects. Applying the back coating also provides a way to adjust the back surface-friction of the medium, which can be important in assisting the feeding of the imaging medium into the ink-jet printer, and typically also provides a way to control the anti-static properties to the ink-jet medium.

In addition, in one embodiment a barrier layer may be added to the imaging surface of substrate 12 to protect the substrate from moisture or co-solvent. A representative barrier layer suitable for use herein include UV-cured layers as disclosed in U.S. Pat. No. 6,610,388, incorporated herein by reference thereto.

In one embodiment the ink jet medium comprises a cationic archival layer, as above described, and a non-ionic layer wherein the nonionic fast dry layer comprises a nonionic binder polymer and at least one nonionic particle selected from the group consisting of nonionic organic and nonionic inorganic particles.

### Surface Layers and Cationic Archival Layer

The following examples show the fast drying ink jet recording medium of the instant invention. The fast drying ink jet recording medium is shown with the cationic archival layer (Layer A) with the anionic surface layer (Layer B) and with an optional fast drying undercoat layer (Layer C). Comparative examples show the effect on color fading, cracking and dry time absent the combination of a cationic archival layer and a fast dry anionic surface layer.

### Layer A: Cationic Archival Layer

In order to meet the requirement for air/ozone fastness, it is important that the archival layer is constructed of swellable or hybrid type of coatings, which consist of at least a water swellable/soluble polymer resin. The water swellable polymer resins or combinations of water swellable resins and inorganic/organic particles may provide light fastness for the imaged “media”. Examples of suitable resins include poly(vinyl alcohol), cellulose derivatives, gelatins, polyvinyl acetal, poly(vinyl acetate), poly(acrylic acid), poly(ethylene oxide), alginates, water-soluble gums, or starch, preferably poly(vinyl alcohol), gelatins, polyvinyl acetal and poly(vinyl acetate).

It is important that this archival layer contains at least a cationic component, which could be cationic binders, a catonic pigments, or mordants. The cationic layer may act as a mordant (dye-fixative) and this can include cationic polymers and can include cationic polyurethane with built-in quaternary ammonium groups. Representative cationic components are available as cationic polyurethanes available under the trade name of Witcobond W-215 and W-213, cationic polyacrylates available under the trade name of Truedot DPX8535-73 and EspriJET 3826, quaternary ammonium salt of polyethylene imine, polydiallyamine or an alkylamine polymer, polydimethylaminoethyl-methacrylate quaternary salts, polystyrene quaternary ammonium salts, polydiallydimethyl ammonium salts, polypyridine and water soluble metal salts.

The archival layer may beneficially also has some ability to absorb or at least be permeable to common co-solvent, such as glycols and glycol ethers which may be present in the inks, icluding pigment based inks. Polymer resins with a solubility parameter close to that of the co-solvent are desirable. Examples of such resins may include polyurethane, PVP, PEOX, PEO, PEO-PPO, cellulose derivatives, polyacrylates, poly(ethylene-co-acrylic acid), poly(ethylene-co-vinyl acetate), polyacetate, polyvinyl acetate and gelatins.

For a glossy ink-receptive medium, it is important that the components be compatible. Being compatible means that the dried coating is preferably glossy and preferably clear on the substrate layers.

Examples of representative compositions for the Cationic Archival Layer (Layer A) are:

TABLE 1
Formula A1

| | |
|---|---|
| Poval 235¹ | 67% dry part |
| Witcobond 213² | 33% dry part |

Formula A2

| | |
|---|---|
| Truedot DPX8535-73³ | 100% dry part |

Formula A-C1 (comparative example)

| | |
|---|---|
| PVP K-60⁴ | 55% dry part |
| Celvol 523⁵ | 15% dry part |
| Sancure 81⁶ | 30% dry part |

¹Poval 235: Polyvinyl alcohol from Kuraray;
²Witcobond 213: Cationic polyurethane emulsion from Crompton;
³Truedot: Cationic polyacrylate emulsion from Mead Westvaco;
⁴PVP K-60: Polyvinylpyrrolidone from ISP.
⁵PVA 523S: Polyvinyl alcohol from Celanese.
⁶Sancure 815: Polyurethane dispersion from Noveon.

### Layer B: Anionic Fast-Dry Overcoat Layer

Since the archival layer can contain a significant amount of water swellable resins, it is important to have a fast-dry surface or overcoat layer in order to optimize several key performance aspects, such as dry time for dye inks and universal printability with pigmented inks. Hybrid or porous type coatings are good choice for fast dry time. The overcoat layer preferably comprises an anionic or nonionic swellable polymer resin and anionic or nonionic inorganic/nonionic particles. The coat weight of the overcoat layer should be minimized as long as the desirable dry time and universal printability are achieved. This is important for a porous/microporous type overcoat layer. It is also preferred that the fast dry overcoat layer be constructed using polymer resins and inorganic/organic particles that provide relatively good light fastness.

As described above, the overcoat layer is preferably constructed with anionic or nonionic swellable polymer resins and anionic or nonionic inorganic/organic particles. Suitable particles may include inorganic precipitated silica, fumed silica, gel silica, sol silica, colloidal silica, and organic particles of polyurethane, polyacrylates, polyvinyl acetate, EVA and EAA.

Controlling swellability of the overcoat layer is critical. Swellability is defined as the microscopic/macroscopic dimensional change of a coating upon absorbing water and co-solvents in ink. A coating that is constructed with more water soluble/swellable polymer resins usually has higher swellability. Porous coating that is constructed with water insoluble inorganic/organic particles usually has lower swellability. It is found that high swellability of a coating can cause image issue for pigment inks. A typical phenomenon is cracking of pigment colorants, especially black colorant, upon drying on the coating. In this invention, therefore, it is desirable that the overcoat layer has less swellability than the archival under layer.

Swellability of a coating is also related to coat weight. A coating with less coat weight swells more until this maximal swelled dimension is reached. The coat weight must be optimized in order to control maximal swellability and allow a fast dry time.

For hybrid type overcoat layer, it is important to select specific combination of swellable polymer resins and inorganic/organic particles that allows penetration and/or diffusion of dye inks, including dye molecules, water and co-solvent. Suitable particles may include inorganic precipitated silica, fumed silica, gel silica, sol silica, colloidal silica, and organic particles of polyurethane, polyacrylates, polyvinyl acetate, EVA, EAA. Suitable polymer resins may include cellulose and cellulose derivatives, PVOH, polyurethane, polyacrylates, polyvinyl acetate, EVA, EAA, PVP, PEOX, PEO, PEO-PPO, etc. It is found that the combination of anionic polymers and anionic inorganic particles are well suited for forming the fast drying anionic overlayer. The combination of cellulose derivatives (e.g. Methocel) and anionic silica (e.g. Ludox, Sylojet, etc.) is well suited for forming the anionic overcoat layer 14.

For a glossy ink-receptive medium, like the archival layer, it is important that all components, including water swellable resins, co-solvent swellable resins and inorganic/organic particles, are compatible. Being compatible means that the dried coating is glossy and clear on the substrate layers.

Examples of representative compositions for the Anionic fast dry Overcoat Layer (Layer B) are:

TABLE 2
Formula B1 (anionic layer)

| | |
|---|---|
| Ludox AS40¹ | 45% dry part |
| Methocel E15² | 45% dry part |
| Sancure 825³ | 10% dry part |

Formula B2 (microporous anionic layer)

| | |
|---|---|
| Nalco TX12143⁴ | 90% dry part |
| Celvol 805⁵ | 10% dry part |

Formula B-C1 (comparative example)

| | |
|---|---|
| Dispal 23N4 20⁶ | 45% dry part |
| Methocel E15 | 45% dry part |
| Witcobond 213⁷ | 10% dry part |

Formula B-C2 (comparative example)

| | |
|---|---|
| Dispal 23N4 20⁶ | 50% dry part |
| Celvol 523S⁵ | 50% dry part |

¹Ludox AS40: Colloidal silica dispersion from Grace Davison.
²Methocel E15: Hydroxy Propyl Methyl Cellulose from Dow Chemical.
³Sancure 825: Polyurethane dispersion from Noveon.
⁴Nalco TX12143: Colloidal silica dispersion from Nalco.
⁵Celvol 805: polyvinyl alcohol from Celanese.
⁶Dispal 23N4 20: Alumina Dispersion from Sasol.
⁷Witcobond 213: Polyurethane emulsion from Crompton;

### Optional Layer C: Fast Dry Undercoat Layer

In order to enhance the dry time, a fast dry undercoat layer can be used.

In one embodiment, the fast dry undercoat is prepared from UV curable methods.

Examples of representative compositions for fast dry Undercoat Layers (Layer C) are:

TABLE 3
Formula C1

| | | |
|---|---|---|
| Ludox AS40¹ | 50% | dry part |
| Methocel E15² | 50% | dry part |

Formula C2 (UV curable coating)

| | | |
|---|---|---|
| CN 2400³ | 26% | dry part |
| CD 9038⁴ | 69% | dry part |
| Darocur MBF⁵ | 5% | dry part |

Formula C2 (UV curable coating)

| | |
|---|---|
| Saromer CN 2400⁶ | 10% |
| Sartomer 9038⁷ | 76% |
| DI Water | 8.50% |
| Potassium Borate | 1.50% |
| Darocure MB⁸ | 1.50% |
| Lucirin TPO-L⁹ | 2.5% |

Formula C4 (microporous type)

| | | |
|---|---|---|
| Poval 235¹⁰ | 8% | dry part |
| Dispal 14N4-80¹¹ | 92% | dry part |

¹Ludox AS40: Colloidal silica dispersion from Grace Davison.
²Methocel E15: Hydroxy Propyl Methyl Cellulose from Dow Chemical.
³CN 2400: Metallic acrylate from Sartomer.
⁴CD 9038: Ethoxylated Bisphenol A Diacrylate from Sartomer.
⁵Darocur MBF: Benzeneacetic acid, .alpha.-oxo-, methyl ester from Ciba.
⁶Saromer CN 2400^{:} Metallic Acrylate Ester Oligomer
⁷Sartomer 9038^{:} Ethoxylated (3) Bisphenol A Diacrylate
⁸Darocure MB^{:} Bemzeneacetic acic, alpha = oxo, methyl ester
⁹Lucirin TPO-L^{:} Ethyl-2,4,6-Trimethylbenzoylphenylphosphinate
¹⁰Poval 235: Polyvinyl alcohol from Kuraray.
¹¹Dispal 14N4-80: Alumina Dispersion from Sasol.

### Substrate

In this invention, the type of substrates is not critical. Suitable substrates include paper, polyester film, vinyl film, polypropylene film, etc. In the case of a photo paper, a paper substrate is preferred. Paper substrates are known in the ink-jet industry, and any suitable paper may be used to make the ink-jet media of the present invention. For example, plain papers, clay-coated papers, or resin-coated papers may be used. The paper substrate may be pre-treated with conventional adhesion promoters to enhance adhesion of the coatings to the paper. The paper substrate has two surfaces. The first surface, which is coated with the radiation-cured and ink-receptive layers in accordance with this invention, may be referred to as the “front” or “imaging” surface. The second surface, which is opposite to the first surface, may be referred to as the “back” or “non-imaging” surface.

In one embodiment, the substrate is a clay-coated paper. Clay-coated paper provides additional absorptivity for ink vehicles. In another embodiment, the substrate is a polyethylene-coated paper. Such papers can have good dimensional stability and moisture resistance. The polyethylene coating acts as a moisture-barrier layer helping to prevent the aqueous ink vehicle from permeating into the base paper and therefore preventing curling of the paper's edges and cockling of the paper's surface. In another embodiment, the substrate is a paper containing a radiation-cured barrier layer, such as disclosed in U.S. Pat. No. 6,610,388, cited here as reference.

Substrate 12 may be a polymeric film comprising a polymer such as, for example, polyethylene (PE), polypropylene (PP), polyester, naphthalate, polycarbonates, polysulfone, polyether sulfone, poly(arylene sulfone), cellulose triacetate, cellophane, polyvinyl chloride, polyvinyl fluoride, polyimides, polystyrene, polyacrylics, polyacetals, ionomers, and mixtures thereof. In other instances, a metal foil such as aluminum foil or a metal-coated material can be used as the substrate 12.

### Backcoat

In addition, the back surface of the base substrate may be coated with a polymeric layer that further helps prevent moisture from penetrating into the base paper. The polymeric coating on the back surface of the paper enhances the paper's dimensional stability and helps minimize paper curling, cockling, and other defects. The back coating also provides surface-friction to assist feeding of the imaging medium into the ink-jet printer. The back coating typically also provides anti-static properties to the ink-jet imaging medium.

### Test Methods

### Light Fastness/Ozone Fastness

Ink jet image colors fade under exposure to sunlight or air pollutant such ozone. The commonly used coordinate system for color is the CIE-L*a*b* system. In order to quantitatively measure the light or ozone fastness, L*a*b* values are measured before (initial L*a*b* values) and after (final L*a*b* values) the samples are exposed to sunlight or ozone.

.DELTA.E=((L.sub.f*--L.sub.i*).sup.2+(a.sub.f*--a.sub.i*).sup.2+(b.sub.f*--b.sub.i*).sup.2).sup.1/2.

.DELTA.E is a measure of the color difference between the faded and unfaded colors. Samples and colors having poor light or ozone fastness have larger .DELTA.E values. The values of L*a*b* were measured with a X-Rite 918 0/45 Colorimeter (X-Rite, Inc.). Testing images are printed with a HP5550 printer using “premium photo paper, glossy, best” mode.

For light fastness test, the printed image containing squares of full cyan, yellow, magenta, composite black, red, green and blue colors are kept in a Atlas SUNTEST CPS+ fadeometer for 40 hours. The fadeometer is equipped with a type C quartz/window glass filters and its radiation exposure is set at 855 KJ/m.

For ozone fastness test, the printed image containing squares of full cyan, yellow, magenta, composite black, red, green and blue colors are kept in a ozone chamber for 24 hours. The concentrate of ozone is measured about 5 ppm.

### Drytime

Dry time measures the speed that an inkjet ink is absorbed by the media. In order to quantitatively measure the dry time, strips of full cyan, yellow, magenta, composite black, red, green and blue colors are printed. Immediately after the printing, a blocking paper is laid over the color strips and rolled over by a 6-lb roller for two passes. Dry time is defined as the minimal time required to allow no ink transfer onto the blocking paper after printing. Testing images are printed with a HP5550 printer using “premium photo paper, glossy, best” mode.

The instant invention demonstrates dry times of 4 minutes or less by use of a cationic archival layer and an anionic overcoat layer, whereas the prior art dry times have been observed to be as much as 10 minutes with associated cracking and reduced light fastness.

### Crack Rating:

Cracking manifests itself as gloss reduction of the final product. Also it causes image imperfections like inter-color ink bleeding know in the industry as “feathering”, where the volume of ink of one color rapidly spreads out along the star shaped “channels” to the adjacent area of the other color causing a print defect. The criteria for the degree of cracking are based on visual inspection of the image surface of the coated substrates. For testing, a black square of 10 cm by 10 cm is printed on the final product and examined under an optical microscope at 5 times magnification.

### Pigment Ink Compatibility

The image is printed with an Epson C84 printer using Durabrite pigmented inks. The medium is regarded as pigment ink compatible if no cracks are shown.

### Gloss Ratings

Gloss of the coated products of the instant invention can be 20 or above and preferable 30 or above. (Micro-TR1-gloss meter marketed by BYK-Gardner used to evaluate surface gloss.)

### Exempary and Comparative Examples

Exempary and Comparative Examples of 5 ink jet media were prepared using one or more of Layer A, Layer B and Layer C. Examples 1 and 2 were prepared according to the instant invention and show excellent dE Light, drytime and demonstrate no cracking. These samples are deemed to be pigment ink compatible.

TABLE 4

| | A Layer | | B Layer | | C Layer | | | | | |
|---|---|---|---|---|---|---|---|---|---|---|
| | Formula | CW | Formula | CW | Formula | CW | | Drytime | dE Light | |
| ID | (charge) | (gsm) | (charge) | (gsm) | (charge) | (gsm) | Substrate | (minutes) | (SUM) | C84 PQ |
| Example #1 | A1 (+) | 10 | B1 (−) | 2 | — | — | Schoeller | 4 | 28.9 | No cracking |
| | | | | | | | PE¹ | | | |
| Example #2 | A1 (+) | 10 | B1 (−) | 2 | C2 (−) | 5 | Aquajet² | 2.6 | 52 | No cracking |
| Comparative | A-C1 (−) | 9 | B-C1 (+) | 5 | — | — | Barrier- | 5 | 103.6 | No cracking |
| Example #1 | | | | | | | coated | | | |
| | | | | | | | Aquajet³ | | | |
| Comparative | A1 (+) | 10 | B-C1 (+) | 2 | — | — | Schoeller | 4 | 35.4 | No cracking |
| Example #2 | | | | | | | PE¹ | | | |
| Comparative | A1 (+) | 10 | — | — | — | — | Schoeller | 10 | 32.3 | Cracking |
| Example #3 | | | | | | | PE¹ | | | |

¹Polyethylene coated paper.
²Aquajet is a coated paper available from Black.
³Aquajet coated with a UV-cured barrier coating.

Use of a cationic archival layer and an anionic fast-dry overcoat layer provides improved dry times, light fastness and suitability for pigment-based inks.

What is claimed is:

1. An inkjet medium comprising:
a) a substrate having an imaging surface;
b) at least one cationic archival layer overlaying the imaging surface of the substrate; and
c) at least one anionic fast-dry overcoat layer overlying the cationic archival layer.

2. The inkjet medium of claim 1 wherein the cationic archival layer comprises at least one cationic component selected from the group comprising cationic binders, cationic pigments and mordants.

3. The inkjet medium of claim 2 wherein the cationic component in the cationic archival layer is selected from the group consisting of cationic polymers, water soluble metal salts, cationic organic particles and cationic inorganic particles.

4. The inkjet medium according to claim 3 wherein the cationic component is selected from the group comprising cationic polyurethane containing quaternary ammonium groups, cationic polyacrylates, quaternary ammonium salt of polyethylene imine, polydiallyamine or an alkylamine polymer, polydimethylaminoethyl-methacrylate quaternary salts, polystyrene quaternary ammonium salts, polydiallydimethyl ammonium salts, polypyridine and water soluble metal salts.

5. The inkjet medium according to claim 1 wherein the anionic overcoat layer is selected from the group comprising anionic polymers, anionic organic particles and anionic inorganic particles.

6. The inkjet medium according to claim 5 wherein the anionic overcoat layer contains at lkeast one component selected from the group consisting of precipitated silica, fumed silica, gel silica, sol silica, colloidal silica, organic particles of polyurethane, polyacrylates, polyvinyl acetate, EVA and EAA.

7. The inkjet medium according to claim 1 wherein the cationic archival layer and the anionic fast-dry overcoat layer comprise water swellable polymers.

8. The inkjet medium according to claim 7 wherein the cationic archival layer and the anionic overcoat layer are water swellable and the anionic fast-dry overcoat layer is less water swellable than the cationic archival layer.

9. The inkjet medium of claim 8 wherein the water swellable polymer in the cationic archival layer is selected from the group comprising poly(vinyl alcohol), cellulose derivatives, gelatins, polyvinyl acetal, poly(vinyl acetate), poly(acrylic acid), poly(ethylene oxide), alginates, water-soluble gums, or starch, preferably poly(vinyl alcohol), gelatins, polyvinyl acetal and poly(vinyl acetate).

10. The inkjet medium of claim 8 wherein the water swellable polymer in the anionic overcoat layer is selected from the group comprising polyurethane, polyacrylates, polyvinyl acetate, EVA, EAA. Suitable polymer resins may include cellulose and cellulose derivatives, PVOH, polyurethane, polyacrylates, polyvinyl acetate, EVA, EAA, PVP, PEOX, PEO and PEO-PPO.

11. The inkjet medium of claim 10 wherein the anionic overcoat layer comprises an anionic cellulose derivative and anionic silica.

12. The inkjet medium according to claim 1 wherein the cationic archival layer contains at least one polymer having a solubility for any co-solvent in the ink.

13. The inkjet medium according to claim 12 wherein the polymer is selected from the group comprising polyurethane, PVP, PEOX, PEO, PEO-PPO, cellulose derivatives, polyacrylates, poly(ethylene-co-acrylic acid), poly(ethylene-co-vinyl acetate), polyacetate, polyvinyl acetate and gelatins.

14. The inkjet medium according to claim 1 wherein the anionic fast dry overcoat layer has less swellability than the archival under layer for the co-solvent.

15. The inkjet medium according to claim 12 where in the ink is a pigment ink.

16. The inkjet medium according to claim 1 wherein the cationic archival layer contains at least one cationic species selected from the group consisting of cationic polyurethanes and cationic polyacrylates and the anionic overcoat layer contains at least one anionic species selected from the group consisting of anionic silica and water soluble anionic polymers.

17. The inkjet medium according to claim 16 wherein the cationic archival layer is a mixture of cationic polyurethane and polyvinyl alcohol and the anionic overcoat layer is a mixture of anionic silica and anionic cellulose derivative.

18. The inkjet medium according to claim 1 wherein the anionic overcoat layer has a coating weight between about 1 g/m² and about 10 g/m² and the cationic archival layer has a coating weight between about 2 g/m² and about 20 g/m².

19. An inkjet medium comprising:
a) a substrate having an imaging surface;
b) at least one fast dry undercoat fast-dry layer overlaying the imaging surface of the substrate;
c) at least one cationic archival layer overlaying on the imaging surface of the anionic fast dry undercoat layer; and
d) at least one anionic fast-dry overcoat overlying the cationic archival layer.

20. The inkjet medium of claim 19 wherein the fast dry undercoat layer is selected form the group consisting of UV-cured layers, a microporous layers and anionic layers.

21. The inkjet medium of claim 19 wherein a barrier layer is place on the substrate before the fast dry undercoat layer.

22. An inkjet medium comprising:
a) a substrate;
b) at least one cationic archival layer coated on the substrate; and
c) at least one non-ionic fast dry overcoat layer coated on the cationic archival layer.

23. The inkjet medium of claim 22 wherein the cationic layer comprises at least one cationic component selected from the group consisting of cationic binders, cationic pigments and cationic mordants.

24. The inkjet medium of claim 23 wherein the cationic component is selected from the group consisting of cationic polymers, water soluble metal salts, cationic organic particles and cationic inorganic particles.

25. The inkjet medium according to claim 24 wherein the cationic component is selected from the group comprising cationic polyurethane containing quaternary ammonium groups, cationic polyacrylates, quaternary ammonium salt of polyethylene imine, polydiallyamine or an alkylamine polymer, polydimethylaminoethyl-methacrylate quaternary salts, polystyrene quaternary ammonium salts, polydiallydimethyl ammonium salts, polypyridine and water soluble metal salts.

26. The inkjet medium according to claim 22 wherein the cationic archival layer and the nonionic fast-dry overcoat layer are water swellable.

27. The inkjet medium of claim 26 wherein the cationic archival layer and the nonionic fast-dry overcoat layer comprise water swellable polymers and the nonionic fast-dry overcoat is less water swellable than the cationic archival layer.

28. The inkjet medium according to claim 22 wherein the nonionic fast dry layer is a nonionic binder polymer and at least one nonionic particle selected from the group consisting of nonionic organic and nonionic inorganic particles.
